(19) United States
(12) Patent Application Publication
(10) Pub. No.: US 2023/0028169 A1
(43) Pub. Date: Jan. 26, 2023

(54) VEHICLE FRONT STRUCTURE

(71) Applicant: TOYOTA JIDOSHA KABUSHIKI KAISHA, Toyota-shi Aichi-ken (JP)

(72) Inventor: Hisato Sawada, Nissin-shi Aichi-ken (JP)

(73) Assignee: TOYOTA JIDOSHA KABUSHIKI KAISHA, Toyota-shi Aichi-ken (JP)

(21) Appl. No.: 17/849,900

(22) Filed: Jun. 27, 2022

(30) Foreign Application Priority Data
Jul. 26, 2021 (JP) 2021-121386

(51) Int. Cl. B60J 5/04; B60K 37/04; B60Q 3/14

(52) U.S. Cl. CPC B60J 5/0413; B60K 37/04; B60Q 3/14

(57) ABSTRACT

A door recessed portion is formed in an upper part of an inner wall surface of a door such that the door recessed portion is recessed outwardly in the vehicle width direction in a state where the door is closed. An operation tool configured to unlock the door is provided on the inner side of the door at a position avoiding the door recessed portion. The door recessed portion has a shape in which a curved surface curved to be recessed in the vehicle width direction continues in the front-rear direction. An instrument panel includes an instrument-panel recessed portion having a shape in which a curved surface curved to be recessed forward continues in the vehicle width direction. An edge line of an upper end of the instrument-panel recessed portion continues with an edge line of an upper end of the door recessed portion.

### CROSS-REFERENCE TO RELATED APPLICATION

This application claims priority to Japanese Patent Application No. 2021-121386 filed on Jul. 26, 2021, incorporated herein by reference in its entirety.

### BACKGROUND

### 1. Technical Field

The present disclosure relates to a vehicle front structure including a door for a vehicle, the door being configured such that an operation tool is provided on an inner wall surface of the door, the operation tool being used by an occupant of the vehicle to unlock the door.

### 2. Description of Related Art

Japanese Unexamined Patent Application Publication No. 2013-163405 (JP 2013-163405 A) describes a door for a vehicle, the door being configured such that an inside door handle is provided in an upper part of an inner wall surface of the door, the inside door handle being used by an occupant of the vehicle to unlock the door.

### SUMMARY

It is necessary that the inside door handle to be used by the occupant of the vehicle to unlock the door be provided at a position where the occupant can easily reach the inside door handle and the inside door handle can attain good operationability. In the meantime, in order to prevent the door from being unlocked by mistake by the occupant hitting his or her arm against the inside door handle, it is necessary to provide the inside door handle at a position where the occupant sitting on a seat inside the vehicle does not touch the inside door handle unintentionally when the occupant moves his or her arm. Accordingly, in a door for a vehicle in the related art, an inside door handle 12 is provided at a position near an instrument panel 2 in an upper part of an inner wall surface of a door 1, as illustrated in FIG. 5. In a case where the inside door handle is provided at this position, it is necessary that the inner wall surface provided with the inside door handle be placed close to an occupant sitting on a seat in order to secure operationability for the occupant. Accordingly, it is difficult to enlarge a vehicle cabin space in the vehicle width direction.

Further, in a case where a door recessed portion recessed outwardly in the vehicle width direction is provided on the inner wall surface of the door in order to enlarge the vehicle cabin space in the vehicle width direction without considering the design of the instrument panel at all, the door and the instrument panel are formed in a discontinuous design.

In view of this, an object of the present disclosure to enlarge a vehicle cabin space in the vehicle width direction and to achieve a continuous interior design from a door to an instrument panel.

In a vehicle front structure according to the present disclosure, a door recessed portion is formed in an upper part of an inner wall surface of a door such that the door recessed portion is recessed outwardly in the vehicle width direction in a state where the door is closed. An operation tool is provided on the inner wall surface of the door such that the operation tool is placed at a position avoiding the door recessed portion, the operation tool being configured to unlock the door when an occupant of a vehicle moves a latch of the door. The door recessed portion has a shape in which a curved surface curved to be recessed in the vehicle width direction continues in the front-rear direction in a state where the door is closed. The door recessed portion extends to a front end of the inner wall surface of the door. An instrument panel includes an instrument-panel recessed portion having a shape in which a curved surface curved to be recessed forward continues in the vehicle width direction. An edge line of an upper end of the instrument-panel recessed portion continues with an edge line of an upper end of the door recessed portion.

With the vehicle front structure according to the present disclosure, by providing the door recessed portion, it is possible to enlarge a vehicle cabin space in the vehicle width direction, and it is also possible to achieve a continuous interior design from the door to the instrument panel.

The vehicle front structure according to one aspect of the present disclosure may include: a light source for the door recessed portion, the light source being configured to emit light toward a surface of the door recessed portion; and a light source for the instrument-panel recessed portion, the light source being configured to emit light toward a surface of the instrument-panel recessed portion.

In the vehicle front structure according to one aspect of the present disclosure, the light source for the door recessed portion may have a shape extending in the front-rear direction. The light source for the instrument-panel recessed portion may have a shape extending in the vehicle width direction. At least one of the door recessed portion and the instrument-panel recessed portion may curve such that a distance from a corresponding one of the light source for the door recessed portion and the light source for the instrument-panel recessed portion is uniform.

With the present disclosure, it is possible to enlarge a vehicle cabin space in the vehicle width direction, and it is also possible to achieve a continuous interior design from the door to the instrument panel.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a perspective view illustrating a vehicle front structure according to an embodiment of this disclosure when the vehicle front structure is viewed from inside a vehicle;

FIG. 2 is a sectional view taken along a line A-A in FIG. 1;

FIG. 3 is a sectional view taken along a line B-B in FIG. 1;

FIG. 4 is a sectional view taken along a line C-C in FIG. 1; and

FIG. 5 is a perspective view of a door for a vehicle and an instrument panel in the related art when they are viewed from inside the vehicle.

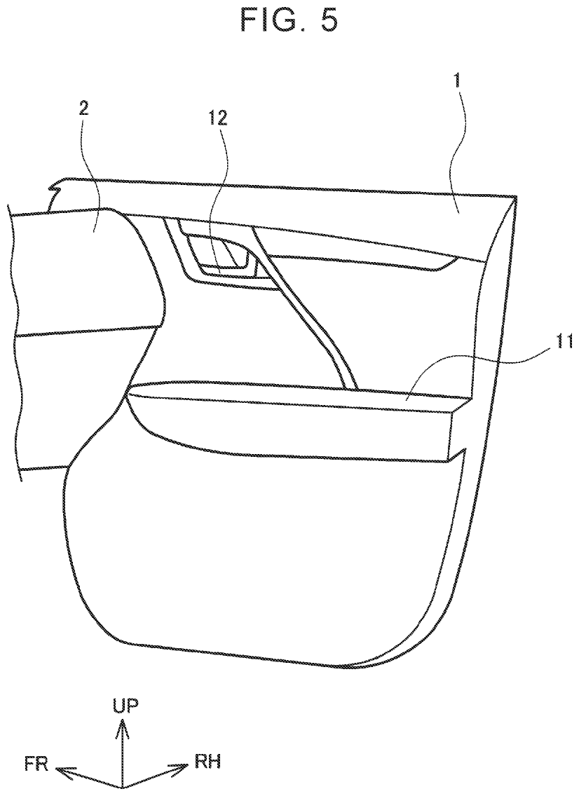

### DETAILED DESCRIPTION OF EMBODIMENTS

With reference to the drawings, the following describes a vehicle front structure 10 of an embodiment of this disclosure. Note that an arrow FR, an arrow UP, and an arrow RH illustrated in each of the drawings described below indicate the front side (the advance side) in the vehicle front-rear direction of a vehicle 20, the upper side in the vehicle up-down direction of the vehicle 20, and the right side in the vehicle width direction of the vehicle 20, respectively. Further, directions reverse to the arrows FR, UP, RH indicate the rear side in the vehicle front-rear direction of the vehicle 20, the lower side in the vehicle up-down direction of the vehicle 20, and the left side in the vehicle width direction of the vehicle 20, respectively. Hereinafter, in a case where a description is made by use of merely the front and rear sides, the right and left sides, and the upper and lower sides, they indicate the front and rear sides in the vehicle front-rear direction, the right and left sides in the vehicle right-left direction (the vehicle width direction), and the upper and lower sides in the vehicle up-down direction, respectively, unless otherwise specified.

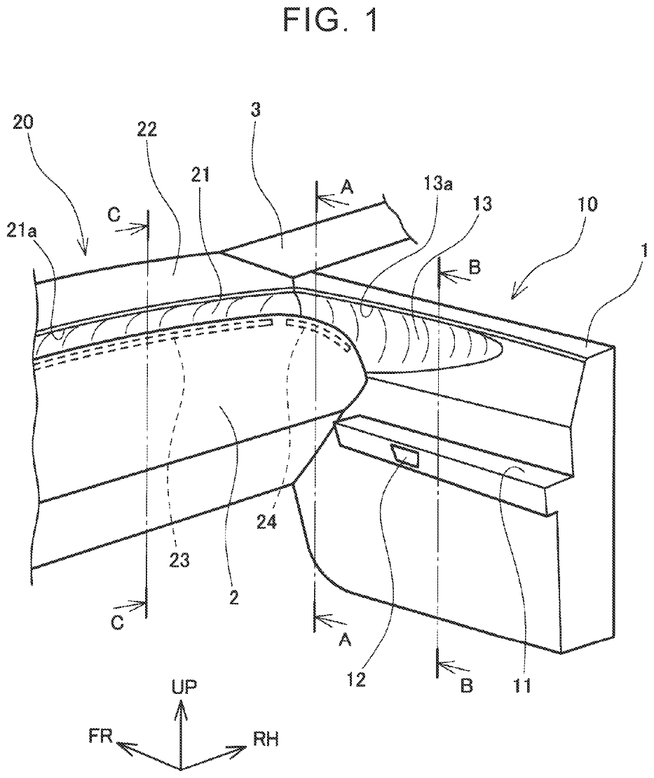

FIG. 1 is a perspective view illustrating the vehicle front structure 10 according to the present embodiment when the vehicle front structure 10 is viewed from inside a vehicle. FIG. 1 illustrates only a right side part of the vehicle front structure 10. As illustrated in FIG. 1, the vehicle front structure 10 includes a door 1 and an instrument panel 2. Since the vehicle 20 is a left hand drive car provided with the vehicle front structure 10, the door 1 on a front passenger side, a part of the instrument panel 2 in front of a front passenger seat, and part of an A-pillar 3 are illustrated in FIG. 1.

FIG. 1 illustrates a state where the door 1 is closed, and an arm rest 11 extending in the front-rear direction is provided in a center part, in the up-down direction, of the inner side of the door 1. An occupant sitting on the front passenger seat can put his or her arm on the top surface of the arm rest 11. An inside door handle 12 is provided on a side face of the arm rest 11. The inside door handle 12 is provided as an operation tool by which the occupant sitting on the front passenger seat can unlock the door 1 by moving a latch of the door 1.

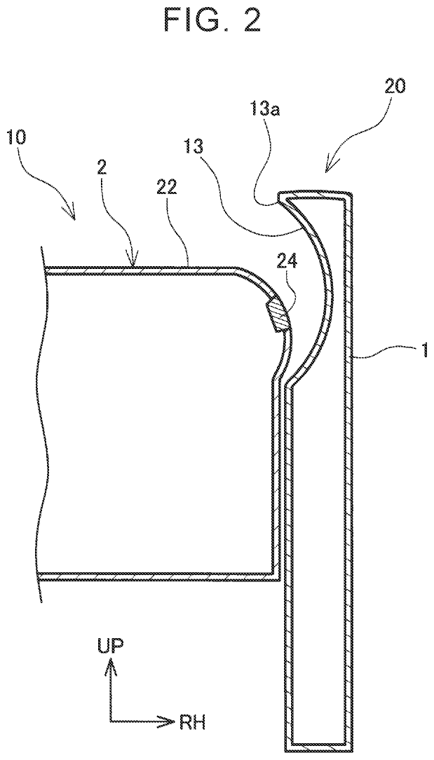

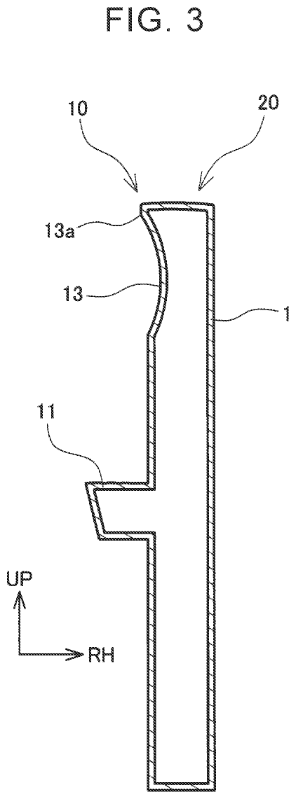

FIG. 2 is a sectional view taken along a line A-A in FIG. 1, and FIG. 3 is a sectional view taken along a line B-B in FIG. 1. Note that, in FIGS. 2, 3, the A-pillar 3 is omitted, and the inner structure of the door 1 is also omitted. As illustrated in FIGS. 1, 2, and 3, a door recessed portion 13 is formed in an upper part of an inner wall surface of the door 1. The door recessed portion 13 has such a shape that a curved surface curved to be recessed outwardly in the vehicle width direction continues in the front-rear direction in a state where the door 1 is closed. In the state where the door 1 is closed, the door recessed portion 13 extends from the vicinity of a central part, in the front-rear direction, of the inner wall surface of the door 1 to a front end of the inner wall surface of the door 1. A rear part of the door recessed portion 13 has a shape that gradually becomes shallower in depth and narrower in width in the up-down direction as it goes rearward. As illustrated in FIGS. 2, 3, the door recessed portion 13 has an arcuate section.

Although the door 1 on a driver side is not illustrated in FIG. 1, the door 1 on the driver side is symmetrical to the door 1 on the front passenger side in the right-left direction, and similarly to the door 1 on the front passenger side, the door 1 on the driver side is provided with the arm rest 11, the inside door handle 12, and the door recessed portion 13.

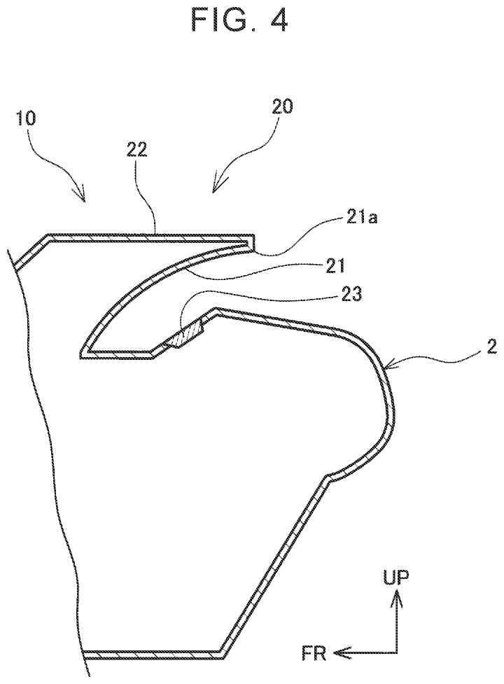

FIG. 4 is a sectional view taken along a line C-C in FIG. 1. As illustrated in FIGS. 1, 4, an instrument-panel recessed portion 21 is formed in the instrument panel 2. The instrument-panel recessed portion 21 has such a shape that a curved surface recessed forward continues in the vehicle width direction. An edge line 21a of an upper end of the instrument-panel recessed portion 21 continues with an edge line 13a of an upper end of the door recessed portion 13. The instrument panel 2 has a horizontal surface 22 that is generally horizontal and extends forward from the upper end of the instrument-panel recessed portion 21.

The instrument panel 2 is provided with an LED light guiding bar 23 as a light source for an instrument-panel recessed portion that is configured to emit light toward the surface of the instrument-panel recessed portion 21. The LED light guiding bar 23 has a shape extending in the vehicle width direction and is placed at a position facing the curved surface of the instrument-panel recessed portion 21. The LED light guiding bar 23 has a structure in which a light emitting diode (LED) is attached to an end part of transparent resin having an elongated bar shape. The LED light guiding bar 23 can emit light over the whole resin having the bar shape by reflecting the light by the inner surface of the resin. As illustrated in FIG. 4, the instrument-panel recessed portion 21 has a section curving in an arcuate shape so that the distance from the LED light guiding bar 23 is uniform. On that account, the curved surface of the instrument-panel recessed portion 21 can uniformly receive light emitted from the LED light guiding bar 23. The LED light guiding bar 23 is placed at a hidden position where the LED light guiding bar 23 is not directly observable from an occupant sitting on a seat inside the vehicle. Accordingly, in the vehicle front structure 10, it is possible to prevent an occupant sitting on the driver seat or the front passenger seat from feeling dazzling by directly seeing the LED light guiding bar 23 emitting light. The occupant sitting on the driver seat or the front passenger seat can see indirect light reflected by the surface of the instrument-panel recessed portion 21 when the LED light guiding bar 23 emits light to the surface of the instrument-panel recessed portion 21.

As illustrated in FIGS. 1, 2, an outer end part of the instrument panel 2 in the vehicle width direction is provided with an LED light guiding bar 24 as a light source for a door recessed portion that is configured to emit light toward the surface of the door recessed portion 13. The LED light guiding bar 24 has a shape extending in the front-rear direction and is placed at a position facing the curved surface of a front part of the door recessed portion 13. Similarly to the LED light guiding bar 23, the LED light guiding bar 24 has a structure in which an LED is attached to an end part of transparent resin having an elongated bar shape. The LED light guiding bar 24 can emit light over the whole resin having the bar shape by reflecting the light by the inner surface of the resin. The LED light guiding bar 24 is placed at a hidden position where the LED light guiding bar 24 is not directly observable from an occupant sitting on a seat inside the vehicle. Accordingly, in the vehicle front structure 10, it is possible to prevent an occupant sitting on the driver seat or the front passenger seat from feeling dazzling by directly seeing the LED light guiding bar 24 emitting light. The occupant sitting on the driver seat or the front passenger seat can see indirect light reflected by the surface of the door recessed portion 13 when the LED light guiding bar 24 emits light to the surface of the door recessed portion 13.

Note that, in FIG. 1, a part of the instrument panel 2 in front of the driver seat is not illustrated but has a structure symmetrical to the instrument panel 2 in the right-left direction except that a meter such as a speedometer is placed in front of the driver seat. The instrument-panel recessed portion 21 and the LED light guiding bar 23 are also provided in the part of the instrument panel 2 in front of the driver seat except a part where the meter is provided. Similarly to the right end of the instrument panel 2, the LED light guiding bar 24 is provided in a left end of the instrument panel 2.

As such, in the vehicle front structure 10, the door recessed portion 13 is formed in the upper part of the inner wall surface of each of the door 1 on the driver side and the door 1 on the front passenger side. Accordingly, it is possible to enlarge a vehicle cabin space in the vehicle width direction. In the vehicle front structure 10, by providing the door recessed portion 13 as such, it is possible to decrease a feeling of pressure that the occupant sitting on the driver seat or the front passenger seat feels and to create sense of quality of the vehicle 20.

Further, in the vehicle front structure 10, the instrument-panel recessed portion 21 and the door recessed portion 13 are provided as such, and the edge line 21a of the upper end of the instrument-panel recessed portion 21 continues with the edge line 13a of the upper end of the door recessed portion 13. This makes it possible to achieve a continuous interior design from the door 1 to the instrument panel 2.

Further, the vehicle front structure 10 includes the LED light guiding bar 23 and the LED light guiding bar 24 as such. Light emitted from the LED light guiding bar 23 is reflected by the instrument-panel recessed portion 21, and light emitted from the LED light guiding bar 24 is reflected by the door recessed portion 13. This makes it possible to achieve a continuous illumination design from the instrument panel 2 to the door 1.

### Supplemental Description of Embodiment

The vehicle front structure of this disclosure is not limited to the above embodiment and can be carried out in various forms within the gist of this disclosure. For example, the door recessed portion may be formed in a shape extending to the vicinity of a rear end of the inner wall surface of the door. Further, the inside door handle may be placed at a different position on the inner wall surface of the door, provided that the position avoids the door recessed portion. Further, as each of the light source for the instrument-panel recessed portion and the light source for the door recessed portion, a single LED point light source may be provided instead of the LED light guiding bar. Alternatively, a light source in which a plurality of point light sources is provided at intervals may be formed.

What is claimed is:

1. A vehicle front structure wherein:
a door recessed portion is formed in an upper part of an inner wall surface of a door such that the door recessed portion is recessed outwardly in a vehicle width direction in a state where the door is closed;
an operation tool is provided on the inner wall surface of the door such that the operation tool is placed at a position avoiding the door recessed portion, the operation tool being configured to unlock the door when an occupant of a vehicle moves a latch of the door;
the door recessed portion has a shape in which a curved surface curved to be recessed in the vehicle width direction continues in a front-rear direction in a state where the door is closed;
the door recessed portion extends to a front end of the inner wall surface of the door;
an instrument panel includes an instrument-panel recessed portion having a shape in which a curved surface curved to be recessed forward continues in the vehicle width direction; and
an edge line of an upper end of the instrument-panel recessed portion continues with an edge line of an upper end of the door recessed portion.

2. The vehicle front structure according to claim 1, comprising:
a light source for the door recessed portion, the light source for the door recessed portion being configured to emit light toward a surface of the door recessed portion; and
a light source for the instrument-panel recessed portion, the light source for the instrument-panel recessed portion being configured to emit light toward a surface of the instrument-panel recessed portion.

3. The vehicle front structure according to claim 2, wherein:
the light source for the door recessed portion has a shape extending in the front-rear direction;
the light source for the instrument-panel recessed portion has a shape extending in the vehicle width direction; and
at least one of the door recessed portion and the instrument-panel recessed portion curves such that a distance from a corresponding one of the light source for the door recessed portion and the light source for the instrument-panel recessed portion is uniform.
